(19) United States
(12) Patent Application Publication
(10) Pub. No.: US 2005/0116687 A1
(43) Pub. Date: Jun. 2, 2005

(54) Charging device and portable electronic equipment comprising same

(75) Inventors: Ichiro Yokomizo, Kyoto (JP); Yoshiyuki Karasawa, Kyoto (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: ROHM CO., LTD.

(21) Appl. No.: 10/995,395

(22) Filed: Nov. 24, 2004

(30) Foreign Application Priority Data
Nov. 28, 2003 (JP) 2003-400293

(51) Int. Cl. H02J 7/00

(52) U.S. Cl. 320/128

(57) ABSTRACT

The present invention provides a charging device that makes it possible to prevent a current control element supplying current from an AC adapter from being turned OFF and to prevent the light emission of a light-emitting element indicating that charging is in progress from being terminated even when there is a reflux current from the secondary cell. The charging circuit constituting the charging device comprises a current control element that supplies current from the output of the AC adapter to the load and secondary cell; a current detection resistor that detects the charging current from the current control element to the secondary cell; a termination current detection circuit that detects a termination current for the completion of charging from the current flowing to the current detection resistor; a charging-current direction detection circuit that detects the direction of the current flowing to the current detection resistor; a charging current control circuit that controls the current control element, a light-emitting element control circuit that controls the light-emitting element, and a light-emitting element driving element that drives the light-emitting element.

### BACKGROUND OF THE INVENTION

1. Field of the Invention

The present invention relates to a charging device that allows a built-in secondary cell to be charged while operating an equipment and to a portable electronic equipment that comprises the charging device.

2. Description of the Related Art

In recent years, a multiplicity of portable electronic equipment such as cellular phones that allow a secondary cell to be charged while the equipment is operated have come into existence (Japanese Patent Application Laid Open No. H8-106926, for example) . FIG. 4 is a block diagram of a portable electronic equipment that comprises a conventional charging device. This portable electronic equipment 101 is constituted by a load 104, which is a part that consumes electrical power by implementing the functions of the portable electronic equipment such as a transceiver circuit or speech processing circuit, and a charging device 103, for example. The charging device 103 is constituted by a secondary cell 105, a charging circuit 106 that charges the secondary cell 105, and a light-emitting element 107 that lights up (emits light) during charging. When the secondary cell 105 is being charged, the portable electronic equipment 101 is connected to the DC output of an AC adapter 102 that is connected to a commercial AC supply line 109.

The charging circuit 106 allows a pre-charging current to flow to the secondary cell 105 during pre-charging at the start of charging and allows a quick-charging current to flow during the subsequent quick-charging. The charging circuit 106 is constituted by a current control element 111 that controls the charging current for the secondary cell 105 and the load current for the load 104 under the control by means of a charging current control circuit 113 (described subsequently); a current detection resistor 112 interposed between the current control element 111 and the secondary cell 105 that allows a charging current to flow; a charging current monitoring circuit 114 that outputs a detection signal to the charging current control circuit 113 so that the charging current flowing to the current detection resistor 112 is at a predetermined quick-charging current value during quick-charging; a termination current detection circuit 116 that detects a state where the charging current flowing to the current detection resistor 112 reaches a predetermined termination current value; a charging voltage detection circuit 117 that detects a state where the voltage of the secondary cell 105 reaches a predetermined voltage value; a charging current control circuit 113 that controls the current control element 111 by inputting detection signals from the charging current monitoring circuit 114, the termination current detection circuit 116 and the charging voltage detection circuit 117; a light-emitting element control circuit 118 that controls the light-emitting element 107 by inputting the detection signals from the termination current detection circuit 116, the charging voltage detection circuit 117 and so forth; and a light-emitting element driving element 119 that drives the light-emitting element 107.

When the portable electronic equipment 101 is connected to the DC output of the AC adapter 102, the charging device 103 starts to charge the secondary cell 105, whereby the voltage thereof is raised and the light-emitting element 107 lights up. Further, the charging of the secondary cell 105 progresses such that, as the maximum value for the charging capacity is approached, the charging current decreases. At length, when the charging current reaches the termination current value, the termination current detection circuit 116 outputs a detection signal to the charging current control circuit 113 and the light-emitting element control circuit 118. Hence, the current control element 111 no longer allows a current to flow from the AC adapter 102 (turns the current OFF), the light-emitting element 107 goes out, and charging of the secondary cell 105 is completed.

Thus, in the charging device 103 of the portable electronic equipment 101, control of the charging of the secondary cell 105 is performed by the charging circuit 106. Further, when the portable electronic equipment 101 is operated at the same time as the charging, a charging current flows toward the secondary cell 105 and a relatively large load current flows toward the load 104. The charging current and load current are supplied from the AC adapter 102 via the current control element 111.

However, most recently, production of portable electronic equipment that allow an extremely large current to flow as the load current, as in the case of cellular phones that send, receive, and display moving images, for example, has begun. When the load current, which is 1A or more, for example, is greater than the limit current value (900 mA, for example) of the AC adapter 102, the possibility then arises that there will be a reflux current from the secondary cell 105 and current will be supplied to the load 104. If there is a reflux of current from the secondary cell 105 that approaches the maximum value of the charging capacity, the termination current detection circuit 116 detects a state where the charging current has reached the termination current value and, even when charging is incomplete, the current control element 111 is then turned OFF, the light-emission of the light-emitting element 107 is terminated and the completion of charging is indicated.

### SUMMARY OF THE INVENTION

With the foregoing in view, it is an object of the present invention to provide, in the case of a portable electronic equipment that allows a secondary cell to be charged while the equipment is operated, a charging device and a portable electronic equipment comprising the charging device that make it possible, even when the load current of the equipment is large and there is a reflux current from the secondary cell such that current is supplied toward the load, to prevent a current control element supplying current from the AC adapter from being turned OFF and a light-emitting element indicating that charging is in progress from indicating that charging is complete.

In order to resolve the above problem, the charging device according to the present invention is a charging device that comprises a secondary cell and a charging circuit that charges the secondary cell, a charging current for the secondary cell and a load current for the load being supplied by means of an AC adapter, wherein the charging circuit comprises a current control element that controls the charging current for the secondary cell and the load current for the load; a current detection resistor interposed between the current control element and the secondary cell that allows the charging current to flow; a charging-current direction detection circuit that detects a state where the current flowing to the current detection resistor flows in a direction from the secondary cell toward the load; a termination current detection circuit that detects a state where the charging current flowing to the current detection resistor reaches a termination current value; and a charging current control circuit that controls the current control element such that current does not flow when a detection signal is inputted from the termination current detection circuit and so that the detection signal of the termination current detection circuit is invalidated when a detection signal is inputted from the charging-current direction detection circuit.

The charging device preferably further comprises a light-emitting element that indicates that charging is in progress, wherein the charging circuit further comprises a light-emitting element control circuit that controls the light-emitting element such that the completion of charging is indicated when a detection signal is inputted from the termination current detection circuit and so that the detection signal of the termination current detection circuit is invalidated when a detection signal is inputted from the charging-current direction detection circuit; and a light-emitting element driving element that drives the light-emitting element.

Further, the portable electronic equipment according to the present invention comprises the charging device; and a load that consumes electrical power by implementing a predetermined function also during charging.

The charging device and portable electronic equipment comprising same according to the present invention are constituted such that, in the case of allowing a secondary cell to be charged while the equipment is operated, even when there is a reflux current from the secondary cell, the reflux current is detected by means of the charging-current direction detection circuit such that even when a termination-current detection signal is inputted from the termination current detection circuit to the charging current control circuit and light-emitting element control circuit, this detection signal is invalidated. Hence, even when there is a reflux current from the secondary cell, a current control element supplying current from the AC adapter can be prevented from being turned OFF and a light-emitting element indicating that charging is in progress can be prevented from indicating that charging is complete.

### BRIEF DESCRIPTION OF THE DRAWINGS

FIG. 1 is a block diagram of a portable electronic equipment that comprises the charging device according to an embodiment of the present invention.

FIG. 2 shows respective waveforms during charging of the charging device.

FIG. 3 is a circuit diagram for the charging-current direction detection circuit of the charging device.

FIG. 4 is a block diagram of a portable electronic equipment that comprises a charging device according to a prior art.

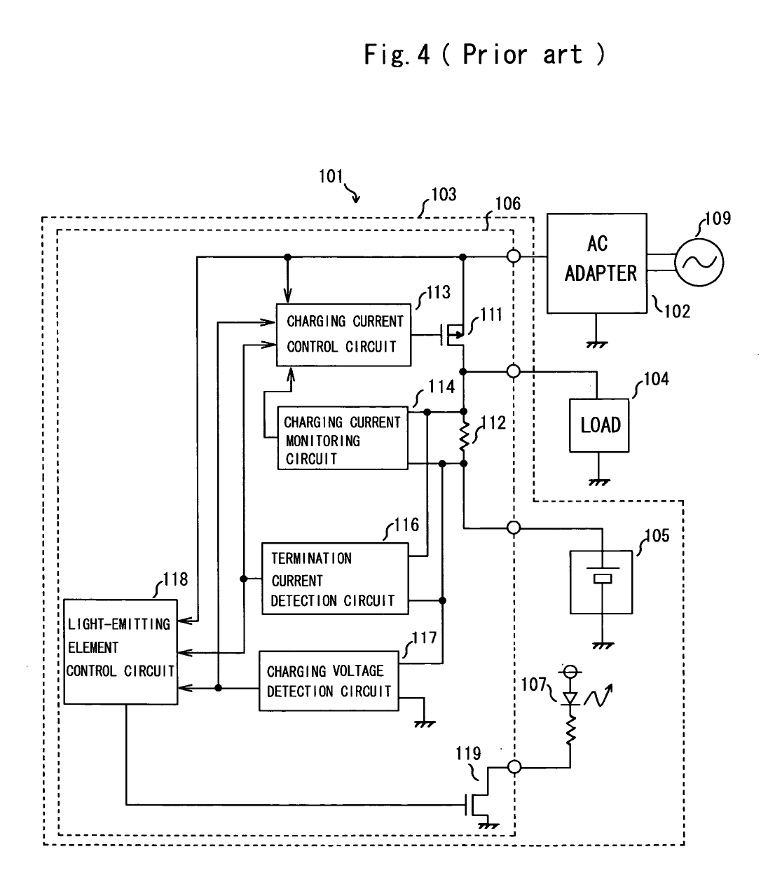

### DETAILED DESCRIPTION OF THE PREFERRED EMBODIMENTS

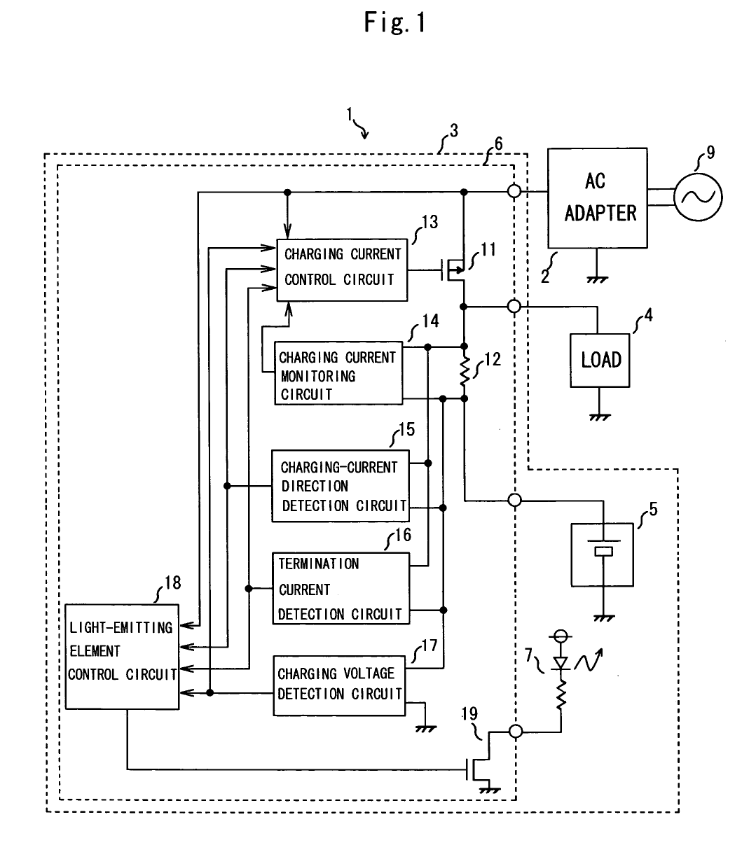

An embodiment of the present invention will be described hereinbelow with reference to the drawings. FIG. 1 is a block diagram of a portable electronic equipment that comprises the charging device according to an embodiment of the present invention. This portable electronic equipment 1 comprises a load 4 and a charging device 3. The load 4 is a part that consumes electrical power by implementing the functions of the portable electronic equipment such as a transceiver circuit, a speech processing circuit and an image (moving image and still image) processing circuit, for example. The charging device 3 comprises a secondary cell 5, a charging circuit 6 that charges the secondary cell 5, and a light-emitting element 7 that lights up (emits light) in order to indicate that charging is in progress. Further, when the secondary cell 5 of the portable electronic equipment 1 is charged, the portable electronic equipment 1 is connected to the DC output of an AC adapter 2, which constitutes the power supply for the charging. The input side of the AC adapter 2 is connected to a commercial AC power supply 9. A limit current value (900 mA, for example) is set for the DC output of the AC adapter 2 and the output voltage of the DC output is a normal voltage up to the limit current value, i.e. 5.8 V, for example, such that the voltage is reduced if the current is at or exceeds the limit current value.

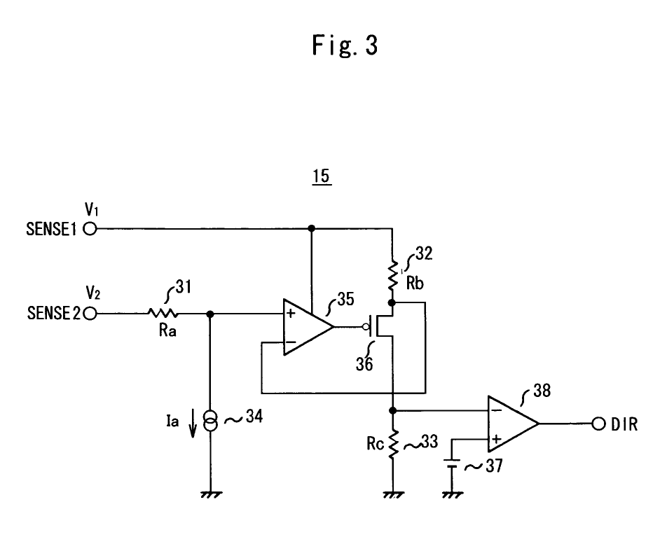

The charging circuit 6 comprises a current control element 11 that controls the charging current for the secondary cell 5 and the load current for the load 4, which is supplied from the power supply (the output of the AC adapter, that is), under the control by means of a charging current control circuit 13 (described subsequently); a current detection resistor 12 interposed between the current control element 11 and secondary cell 5 that allows the charging current to flow; a charging-current direction detection circuit 15 that detects a state where the current flowing to the current detection resistor 12 flows in a direction from the secondary cell 5 to the load 4; a termination current detection circuit 16 that detects a state where the charging current flowing to the current detection resistor 12 reaches a predetermined termination current value; and a charging current control circuit 13 that controls the current control element 11 so that current does not flow when a detection signal is inputted from the termination current detection circuit 16 and so that, when a detection signal is inputted from the charging-current direction detection circuit 15, the detection signal of the termination current detection circuit 16 is invalidated. The specific circuit of the charging-current direction detection circuit 15 will be described in detail subsequently on the basis of FIG. 3. By providing these constituent elements, in the portable electronic equipment 1 that allows the secondary cell 5 to be charged while the portable electronic equipment 1 is operated, even when the load current of the equipment is large and there is a reflux current, which is supplied toward the load 4, from the secondary cell 5, it is possible to prevent the current control element 11, which allows current to flow from the AC adapter 2, from being turned OFF.

In addition, the charging circuit 6 comprises a light-emitting element control circuit 18 that controls the light-emitting element 7, which indicates that charging is in progress, to indicate that charging is complete when the detection signal is inputted from the termination current detection circuit 16 and to invalidate the detection signal of the termination current detection circuit 16 when the detection signal is inputted from the charging-current direction detection circuit 15; and a light-emitting element driving element 19 that drives the light-emitting element 7. By adding these constituent elements, in the portable electronic equipment 1 that allows the secondary cell 5 to be charged while the portable electronic equipment 1 is operated, the indication by the light-emitting element 7 that charging is complete (the cessation of light emission) can be prevented even when the load current of the equipment is large and there is a reflux current, which is supplied to the load 4, from the secondary cell 5.

In addition, the charging circuit 6 comprises a charging current monitoring circuit 14 that outputs a detection signal to the charging current control circuit 13 so that the charging current flowing to the current detection resistor 12 is at a predetermined quick-charging current value during quick-charging; and a charging voltage detection circuit 17 that detects a state where the voltage of the secondary cell 5 becomes a pre-charging voltage during pre-charging, detects a state where the voltage becomes at or above a prescribed voltage during quick-charging, and outputs a detection signal to the charging current control circuit 13. By adding such constituent elements, the charging circuit 6 is able to implement control to allow a pre-charging current to flow to the secondary cell 5 during pre-charging at the start of charging and then allow a quick-charging current to flow during the subsequent quick-charging.

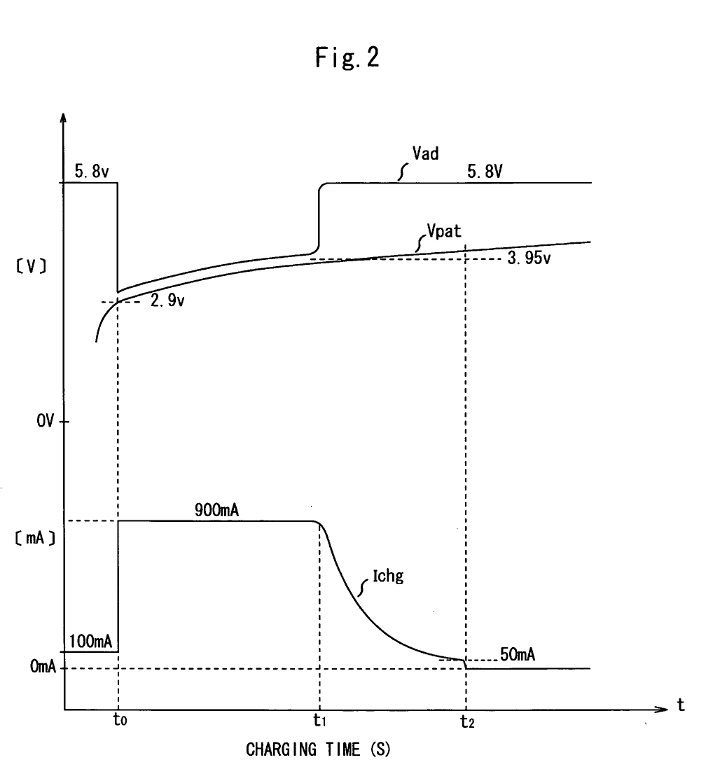

Next, the charging operation will be described on the basis of the waveform diagram shown in FIG. 2. When the portable electronic equipment 1, more specifically the charging device 3, is connected to the AC adapter 2, if an adequate power supply for charging is supplied by the AC adapter 3 and the voltage Vpat of the secondary cell 5 is lower than the predetermined voltage, the charging current control circuit 13 controls the current control element 11 so that a charging current Ichg flowing through the current control element 11 is at a fixed pre-charging current (100 mA, for example) and a pre-charging state at the start of charging is entered. Further, the light-emitting element control circuit 18 controls and drives the light-emitting element driving element 19 to cause the light-emitting element 7 to light up and indicate that charging is in progress.

When the voltage Vpat of the secondary cell 5 rises and is at the pre-charging voltage (2.9 V, for example) (charging time to), the charging voltage detection circuit 17 detects this rise, outputs a detection signal to the charging current control circuit 13, and makes the transition from the pre-charging state to the quick-charging state. The charging current control circuit 13 controls the current control element 11 so that the charging current Ichg flowing through the current detection resistor 12 is the fixed maximum current for the quick-charging (the quick-charging current). This fixed quick-charging current is determined from the limit current value of the AC adapter 2 and is 900 mA, for example. When a state where the quick-charging current is flowing exists (that is, when the current of the limit current value is flowing from the AC adapter 2), the output voltage Vad of the AC adapter 2 drops toward the voltage Vpat of the secondary cell 5 and exceeds the voltage Vpat of the secondary cell 5 to an extent corresponding with the saturation voltage (Vsat) of the current control element 11.

Further, when the secondary cell 5 approaches the maximum value of the charging capacity, the current that is able to flow to the secondary cell 5 decreases and, as a result, the secondary cell 5 is being in the quick-charging state but the charging current Ichg starts to decrease (charging time t₁). Thereupon, the output voltage Vad of the AC adapter 2 returns a normal voltage (5.8 V, for example). In this state, the voltage Vpat of the secondary cell 5 continues to rise, albeit gradually. Further, the charging current Ichg flowing to the current detection resistor 12 decreases and reaches the termination current value (50 mA, for example) (charging time t₂), the termination current detection circuit 16 detects this fact and outputs the detection signal to the charging current control circuit 13 and light-emitting element control circuit 18. Here, if the voltage Vpat of the secondary cell 5 exceeds the prescribed voltage value (3.95 V, for example), the charging voltage detection circuit 17 detects this fact and outputs a detection signal to the charging current control circuit 13 and light-emitting element control circuit 18. The charging current control circuit 13 then turns OFF the current control element 11 (so that no current flows) and the light-emitting element control circuit 18 controls and drives the light-emitting element driving element 19, whereby the light-emitting element 7 is made to go out (light emission is terminated) to indicate that charging is complete, whereupon charging is complete.

When the portable electronic equipment 1 is operated at the same time as the charging takes place, a charging current flows toward the secondary cell 5 and a load current flows toward the load 4. Normally, the charging current and load current are supplied by the AC adapter 2 via the current control element 11. However, when the load current, which is 1A or more, for example, is greater than the limit current value (900 mA, for example) of the AD adapter 102 and load current is supplied by flowing back from the secondary cell 5 toward the load 4, the termination current detection circuit 16 outputs a detection signal to the charging current control circuit 13 and light-emitting element control circuit 18 as if the charging current reaches the termination current value. Here, at the same time, the charging-current direction detection circuit 15 detects the reflux current and also outputs the detection signal to the charging current control circuit 13 and light-emitting element control circuit 18. As a result, the charging current control circuit 13 and light-emitting element control circuit 18 invalidates the detection signal that is inputted from the termination current detection circuit 16.

Therefore, even when there is a reflux current from the secondary cell 5 that approaches the maximum value of the charging capacity (that is, the voltage Vpat exceeds the prescribed voltage value (3.95V, for example)), the current control element 11 can be prevented from turning OFF and the light-emitting element 7 can be prevented from going out. Further, when the portable electronic equipment 1 makes the transition to an operating state where the load current is small or to an operation stoppage state, the charging of the secondary cell 5 is restarted.

Next, a specific circuit example of the charging-current direction detection circuit 15 will be described with reference to FIG. 3. In FIG. 3, the voltages V₁ and V₂ at the two ends of the current detection resistor 12 are inputted to the input terminals SENSE 1 and SENSE 2 respectively. When a forward current is flowing to the current detection resistor 12, voltage V₁ is higher than voltage V₂. A detection signal indicating the direction of the charging current is outputted from the output terminal DIR to the charging current control circuit 13 and light-emitting element control circuit 18. A resistor 31 with a resistance value Ra is connected to the input terminal SENSE 2 and the other end of the resistor 31 is connected to a fixed current source 34 with a current value Ia and to the non-inversion input terminal of an amplifier 35. The gate of a P-type MOS transistor 36 is connected to the output of the amplifier 35, while the source of the P-type MOS transistor 36 is connected to the input terminal SENSE1 via a resistor 32 with a resistance value Rb and the drain of the P-type MOS transistor 36 is connected to ground potential via a resistor 33 with a resistance value Rc. In addition, the source of the P-type MOS transistor 36 is connected to the inversion input terminal of the amplifier 35 and the drain of the P-type MOS transistor 36 is connected to the inversion input terminal of an amplifier 38. The non-inversion input terminal of the amplifier 38 is connected to a charging-current direction detection reference power supply 37 and the output of the amplifier 38 is connected to the output terminal DIR.

The input voltage V₂ of the input terminal SENSE2 drops as a result of the current flowing to the-fixed current source 34 flowing to the resistor 31 and the voltage of the non-inversion input terminal of the amplifier 35 is then V₂−Ia×Ra. The voltage is then the source voltage of the P-type MOS transistor. If the voltages V₁and V₂ of the input terminals SENSE1 and SENSE2 respectively are equal (that is, current does not flow to the current detection resistor 12), a current Ia×Ra/Rb then flows to the resistor 32 and, because this current also flows to the resistor 33, the drain voltage of the P-type MOS transistor 36 is Ia×Ra×Rc/Rb. This voltage value is set as the voltage value of the charging-current direction detection reference power supply 37. When the voltage V₁ of the input terminal SENSE1 is higher than the voltage V₂ of the input terminal SENSE2 (that is, a forward current flows to the current detection resistor 12), the output of the output terminal DIR is a low level output. When the voltage V₁ of the input terminal SENSE1 is lower than the voltage V₂ of input terminal SENSE2 (that is, when a reflux current is flowing to the current detection resistor 12), the output of the output terminal DIR is a high level output. Thus, when a reflux current flows to the current detection resistor 12, a detection signal is outputted from the output terminal DIR.

As described above, when the charging-current direction detection circuit 15 detects a reflux current, the detection of the termination current by the termination current detection circuit 16 is invalidated. Hence, the charging device 3 is used in a portable electronic equipment that allows an extremely large current to flow as a load current as in the case of a cellular phone or the like that sends and receives moving images and displays these images, for example, whereby the current control element 11, which supplies current to the load and secondary cell can be prevented from turning OFF even when charging is incomplete and the light-emitting element 7, which indicates that charging is in progress, can be prevented from going out.

Further, the present invention is not limited to the above embodiment. Rather, a variety of design modifications are possible within the scope of the items appearing in the claims. For example, although the charging voltage detection circuit 17 detects the voltage of the secondary cell 5 as a pre-charging voltage and prescribed voltage and outputs a detection signal to the charging current control circuit 13, the detection of the prescribed voltage can be omitted if the voltage of the secondary cell 5 is regarded as having reached the prescribed voltage when the termination current detection circuit 16 detects the termination current value. Further, the light-emitting element control circuit 18 lights the light-emitting element 7 during charging and turns same off when charging is complete but may, conversely, turn off the light-emitting element 7 during charging and light same when charging is complete. Moreover, light-emitting elements 7 with two different light-emission colors may be provided such that a red light-emitting element is lit during charging and a green light-emitting element is lit when charging is complete, for example.

1. A charging device that comprises a secondary cell and a charging circuit that charges the secondary cell, a charging current for the secondary cell and a load current for the load being supplied by means of an AC adapter, wherein the charging circuit comprises:
a current control element that controls the charging current for the secondary cell and the load current for the load;
a current detection resistor interposed between the current control element and the secondary cell that allows the charging current to flow;
a charging-current direction detection circuit that detects a state where the current flowing to the current detection resistor flows in a direction from the secondary cell toward the load;
a termination current detection circuit that detects a state where the charging current flowing to the current detection resistor reaches a termination current value; and
a charging current control circuit that controls the current control element such that current does not flow when a detection signal is inputted from the termination current detection circuit and so that the detection signal of the termination current detection circuit is invalidated when a detection signal is inputted from the charging-current direction detection circuit.

2. The charging device according to claim 1, further comprising:
a light-emitting element that indicates that charging is in progress,
wherein the charging circuit further comprises:
a light-emitting element control circuit that controls the light-emitting element such that the completion of charging is indicated when a detection signal is inputted from the termination current detection circuit and so that the detection signal of the termination current detection circuit is invalidated when a detection signal is inputted from the charging-current direction detection circuit; and
a light-emitting element driving element that drives the light-emitting element.

3. The charging device according to claim 1, wherein the charging circuit allows a pre-charging current to flow to the secondary cell during pre-charging at the start of charging and allows a quick-charging current to flow during the subsequent quick-charging, the charging device further comprising:
a charging current monitoring circuit that outputs a detection signal to the charging current control circuit so that the charging current flowing to the current detection resistor is at a predetermined quick-charging current value during quick-charging; and
a charging voltage detection circuit that detects a state where the voltage of the secondary cell becomes a pre-charging voltage during pre-charging, detects a state where the voltage becomes equal to or more than a prescribed voltage during quick-charging, and outputs a detection signal to the charging current control circuit.

4. The charging device according to claim 2, wherein the charging circuit allows a pre-charging current to flow to the secondary cell during pre-charging at the start of charging and allows a quick-charging current to flow during the subsequent quick-charging, the charging device further comprising:
a charging current monitoring circuit that outputs a detection signal to the charging current control circuit so that the charging current flowing to the current detection resistor is at a predetermined quick-charging current value during quick-charging; and
a charging voltage detection circuit that detects a state where the voltage of the secondary cell becomes a pre-charging voltage during pre-charging, detects a state where the voltage becomes equal to or more than a prescribed voltage during quick-charging, and outputs a detection signal to the charging current control circuit.

5. A portable electronic equipment, comprising:
the charging device according to claim 1; and
a load that consumes electrical power by implementing a predetermined function also during charging.

6. A portable electronic equipment, comprising:
the charging device according to claim 2; and
a load that consumes electrical power by implementing a predetermined function also during charging.

7. A portable electronic equipment, comprising:
the charging device according to claim 3; and
a load that consumes electrical power by implementing a predetermined function also during charging.

8. A portable electronic equipment, comprising:
the charging device according to claim 4; and
a load that consumes electrical power by implementing a predetermined function also during charging.
